(19) United States
(12) Patent Application Publication
(10) Pub. No.: US 2004/0215694 A1
(43) Pub. Date: Oct. 28, 2004

(54) Automated system and method for integrating and controlling home and office subsystems

(76) Inventor: Leon Podolsky, Skillman, NJ (US)

Correspondence Address: Brian A. Comack, Esq., Amster, Rothstein & Ebenstein, 90 Park Avenue, New York, NY, 10016, US

(21) Appl. No.: 10/400,050

(22) Filed: Mar. 26, 2003

(51) Int. Cl. G06F 15/16

(52) U.S. Cl. 709/201

(57) ABSTRACT

The present invention generally relates to home and/or office automation. More particularly, the present invention implements an open system that uses a gateway server and set top boxes to control security, lighting, home heating, air conditioning and ventilation, and audio and video distribution. By using a system such as the one described herein, a home and/or office autormation system can be easily programmed and operated without specially trained installers. Further, by using popular standards, such as Internet protocols, and a programming language, such as JAVA™, specially developed application and use cases become portable and operable regardless of the manufacturer of the subsystems in the home or office automation system and regardless of components that exist in the home or office automation system.

### FIELD OF THE INVENTION

The present invention generally relates to control of various subsystems which can be automated in a home or office environment. In particular, the present invention implements a system that receives commands from a conventional higher level programming language and converts such commands into proprietary formats understood by the subsystems to be controlled for control of subsystems within a home or office and distributing audio or video content.

### BACKGROUND OF THE INVENTION

In recent times, there has been increasing interest by home owners (as well as office managers) to have integrated control of the various systems that exist in their home. Typically, these subsystems may include an alarm system, a heating, ventilation, and air conditioning (HVAC system), and access to various audio and video devices. Further, a consumer might install components such as a dimmer switch to exercise some degree of control over lighting at a particular locations. Of course, any device within the home may be subject to control from an external point. Various products have been offered to consumers to give them a greater degree of control over the various subsystems that exist in their home.

Prior to the present invention, one solution to give a home owner some degree of control over the various subsystems was to provide access points which allow for each subsystem to be programmed separately. For example, there may be a panel or panels where a user would have access to the security system, allowing them to activate or deactivate the various alarm components. In some cases, a separate panel is provided at another location in the house where users could control a programmable thermostat, thereby providing a degree of control, albeit limited, over the HVAC subsystem. Yet at another location, a separate control system (e.g., programmable dimmers) is provided to program various lighting fixtures. This method of controlling the various subsystems was costly and cumbersome since there is no level of integration between the various subsystems and no unitary control system. As a result, many were reluctant to install and/or use separate control systems in many subsystems in their homes and/or offices.

Others have attempted to solve the home automation problem through the use of proprietary system integration approaches. These proprietary systems generally use unconventional, proprietary programming languages which are difficult to use and require specialized training in order to install and program. Since these systems are proprietary and do not use mainstream hardware and software, they cannot incorporate new devices and equipment into the various subsystems if such devices and equipment are not compatible with the unconventional, proprietary programming languages. Further, if the manufacturer of the proprietary system does not support the existing equipment for a subsystem, there is no simple and straightforward manner in which to integrate a non-supported device into the home and/or office automation system.

Moreover, these proprietary systems generally involve extremely complex wiring, typically requiring many different cabling formats, each of which, requires separate installation. The use of these non-standard cables throughout the home automation system added cost and complexity to an installation, often deterring homeowners from using such systems. More particularly, installation of these prior proprietary home automation systems require complicated system installation and custom programming. First, the specific cables needed for each subsystem must be wired throughout the installation. Then, a separate cable used by the proprietary integration system is installed throughout the installation. Further, the installer must program the entire system using the proprietary language provided by the manufacturer of the home automation equipment. These specific requirements limit the availability of qualified installers for the home automation system to those that had expertise in the proprietary programming language provided by the home automation equipment manufacturer. As a result, dealers for this type of home automation equipment have been at the mercy of the few qualified installers for the proprietary-type home automation equipment.

Some have tried to address these problems by offering software solutions that involve the use of mainstream programming languages. However, the manufacturers offering such software solutions do not offer hardware which is compatible with their software which can be easily integrated into a home automation system. These software solutions typically are implemented on a personal computer which suffers from reliability problems and does not have the ease of use of a system that is built from ground up and is dedicated to the purpose of home automation.

Accordingly, it is an object of the present invention to manage all home subsystems in a low-cost and efficient manner using devices built to operate with conventional programming languages, such as Java™, C++, and/or HTML.

It is a further object of this invention to leverage existing standards such as those developed for the Internet, PC technologies, local area networks, including wireless local area networks, IEEE 1394 and other existing or hereinafter developed standards.

It is a further object of this invention to foster interoperability with existing subsystem controllers which are proprietary to the particular subsystem manufacturer.

It is a further object of this invention to ease the process of installation by using standard wired or wireless network connections for the home automation system up to the points of interface with the subsystems.

It is a further object of this invention to provide a simple interface for the user to understand the status of the home automation system and to control it in its subsystems.

Still farther, it is an object of this invention to allow multiple A/V sources such as satellite, digital cable, off air antennas, surveillance cameras, games, computers and the Internet to be distributed throughout the home automation system from any source of such information to any potential target such as HDTV receiver, television set, LCD panel etc.

It is a further object of this invention to use content enabling technology, such as MacroMedia Flash, to offer a true two-way web-based touch screen control system user interface.

Other objects of this invention will be apparent from the detailed description of the invention provided below.

### SUMMARY OF THE INVENTION

It has now been found that the above and related objects of the present invention are obtained in the form of a system for automating the various subsystems that may exist in a home or an office, such as security, lighting, HVAC and audio or video components. More specifically such objects of this invention can be realized by using a gateway server that can receive input signals from one or more of the various subsystems or from a user and based on such inputs execute preprogrammed applications and “use cases” that were written in a mainstream programming language. The application or use cases drafted in this mainstream programming language are converted by the gateway server using a generic command framework into a proprietary format accepted by the various subsystems connected to the gateway server. Still further one or more devices, such as a set top box, are connected to the gateway server (as well as each other) via a local area network. These devices, which may be set top boxes, are also connected to the various subsystems that are being controlled by them. In a preferred embodiment of this invention such devices can act as a client or server for audio and video contact as well as provide the control for the audio and video subsystems. Finally, the objects of this invention are realized by using an input device, such as a touch screen display, wireless web pad, or the like, for receiving the user's commands in sending such commands to the gateway server for implementation.

In another embodiment of this invention, the gateway server can be eliminated. In this embodiment, the control of the subsystems is given exclusively to the devices, such as set top boxes, which are connected at various points to the subsystems.

### BRIEF DESCRIPTION OF THE DRAWINGS

The above and related objects, features and advantages of the present invention will be more fully understood by reference to the following detailed description of the preferred, albeit illustrative, embodiment of the present invention when taken in conjunction with the accompanying figures, wherein:

FIG. 1 shows a hierarchical framework of implementing an application/use case;

FIG. 2 discloses an illustrative system architecture for the home automation system described in this specification;

FIG. 3 shows a block level diagram of the gateway server used in the home automation system described in the specification;

FIG. 4 shows a block level diagram of the set top devices described in this specification;

FIG. 5 shows the block level schematic of a touch screen controller used in the home automation system described in the specification; and

FIG. 6 shows a block level schematic of a home automation system of the alternative embodiment which is implemented without a gateway server.

### DETAILED DESCRIPTION OF THE INVENTION

The embodiments of the present invention relate to a home and/or office control system that combines audio and video distribution control with a variety of subsystems, including, but not limited to security, lighting and HVAC subsystems. More particularly, the described embodiments disclose the integration of gateway server which is programmable in a mainstream programming language, one or more devices which can serve as multi-media clients and servers, which are also programmable based on mainstream programming languages, and various optional devices such as touch panels (wired or wireless), PDAs, web pads and other user interface devices.

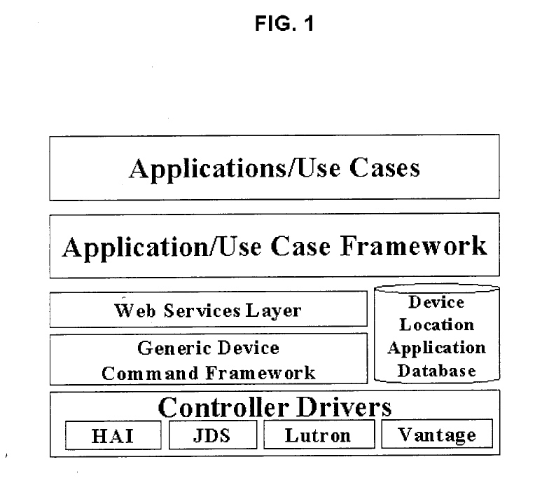

To better understand the disclosed invention, a description of one embodiment of the present invention is provided below. Referring to FIG. 1, an illustrative hierarchical diagram of the layers in the system architecture is shown. Specifically, the system is designed to accept programs that are specific to applications and/or use cases. An application case is, for example, a series of commands that are executed to obtain a desired result across a series of subsystems. A use case is similar to an application case, but is limited to a series of commands to perform a particular function. Application and use cases can range from simple home automation control (e.g., setting “mood” lighting for a particular scene) to complex application and use cases (e.g., reading video from a DVD player attached to a multi-media server to a remote play located elsewhere attached to a multi-media client) and thus, are not limited to the illustrative examples described herein. The next layer of the architectural hierarchy includes the application/use case framework. This application/use case framework is a collection of classes and interfaces that are used as building blocks for application and use cases. Preferably, the application/use case framework is implemented in the same programming language used to build the actual application/use cases.

At the next layer in the architectural hierarchy is the web services layer, the generic device command framework, and the device location application database. The web services layer uses web based standards, including but not limited to HTTP and XML, to encapsulate access to proprietary subsystem functions. The utilization of a web services layer allows applications to be written in a manner that is independent from the particular subsystems being implemented. That is, a programmer drafting an application/use case for an UVAC system, for example, does not have to be concerned about which type of HVAC system is connected to the home automation system. It also allows the programmer to use existing or hereinafter developed open industry standards to communicate with the subsystems.

The generic device command framework is a series of classes and interfaces that can be used by a programmer to develop specific command interfaces to the subsystems. For example, the generic device command framework translates the commands required by web services layer into the format understandable by the proprietary subsystems, such as the subsystems for lighting, HVAC, etc.

The device location application database stores information relating to the components of the subsystems that are installed in the home automation system, such as their location within the home or office, their capabilities, or any other information that would be useful when building the application/use cases. This device location application database has the advantage that by modifying the device location application database different applications or use cases can be used in different facilities without modification based on the equipment that has been installed in that facility. This database enables the application or use case to operate irrespective of the type of equipment in the system. For example, in one facility, an application or use case may function using three lighting dimmer switches and in other facilities, it may operate where there are only one or two dimmer switches installed. A typical entry in the device location database may read, for example, master bedroom, main dimmer, Lutron™ graphic eye, gateway server.

At the bottom layer of the architectural hierarchy are the controller drivers which convert the commands received by implementing the application and use cases into the proprietary formats that are compatible with the attached subsystems.

Having described the general architecture of the present invention, illustrative examples of how the system can be used are now described. The first example illustrates the use of a home automation system to monitor a security violation alert. In this example, the multi-media distribution system is configured to provide particularized control over a security system when a security violation is reported by an alarm. Specifically, when the alarm is activated, the system response module creates a temporary account, log in, and password for use by the central station at the alarm company. A message is transmitted to a predefined port at the central station which contains, for example, a URL link to the remote log in page where an operator at the central station can log in with their password. The operator at the central station can log in using the account log in and password provided. The operator will then be able to view the security violation page generated by the home automation system which describes which of its sensors were tripped to activate the alarm and provides the operator access to the available surveillance devices in the home automation system. The central station operator can click on any of the available devices and a media player, which preferably allows streaming live video and audio, provides the operator information from the surveillance devices in the home automation system. After the central station operator is satisfied that nothing unusual is detected by using the available surveillance devices, they can telephone the end user and confirm that there are no problems apparent from the surveillance equipment and then close the case by returning to the security/violation page provided by the home automation system and pressing the clear violation button. This will close the temporary account in the central station and the connection is terminated.

If, on the other hand, the central station representative observes a problem by using the surveillance equipment, they can notify the appropriate authorities. Thereafter, the central station representative should continue to monitor the home. In this regard, the representative can select and view appropriate pages and media players. Once the representative receives notification from the authorities responding to the situation, the case can be closed by returning to the security/violation page and pressing the clear violation button. This will close the account and the central station connection is terminated. Application and use cases, such as this, can be developed independently of the security equipment utilized in the system as well as independent of the facility itself, as described more fully in regard to the system components below.

Another example of a use case, is the capture and save lighting scene use case now described. In this use case, the state of the light dimmers and switches in specified areas can be set by the user and stored in the home automation system in a lighting scene named by the actor. This allows the end user to manually set the state of any number of dimmers and switches, go back to an input device such as a touch screen, select the lighting/capture scene feature, specify a name for the currently selected location and, by pressing a button, capture the lighting scene and assign it to the specified name. The programming of this use case might be quite complicated, but it only has to be done once for use on the home automation system of this invention since the program can run on any installation of the home automation system of this invention regardless of the particular hardware that is included in the lighting subsystem.

It is noted the examples described herein are only illustrative and thus, the present invention is not limited to the programming possibilities described with respect to these examples.

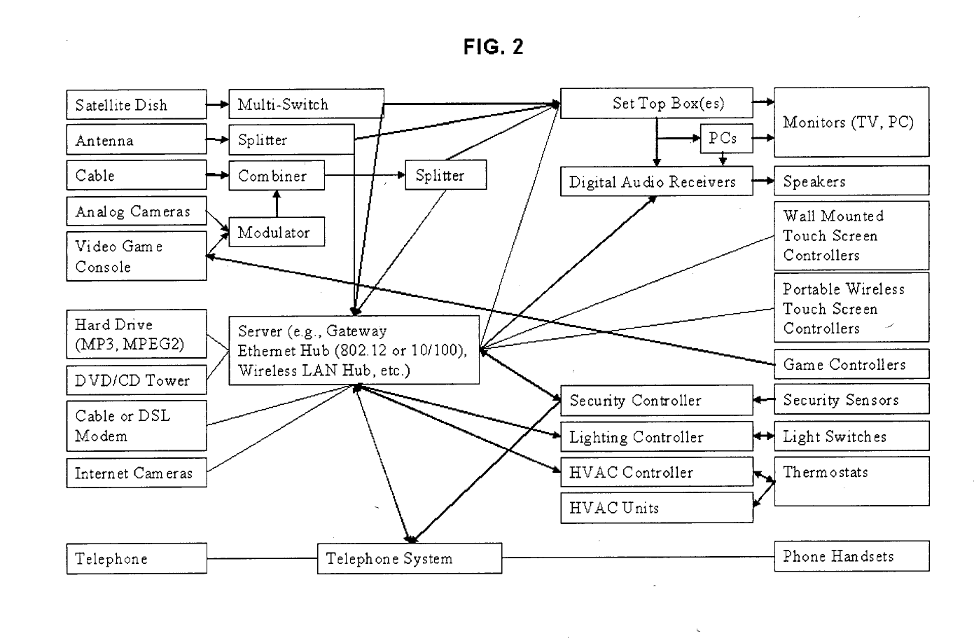

FIG. 2 shows a block schematic of one embodiment of the home automation system of the present invention. Specifically, the system of this embodiment is preferably controlled by a gateway server that is compatible with a networking standard, such as Ethernet (IEEE 802.12 or 10/100 bps) or wireless LAN standards. The server can be connected to various optional components such as a hard drive which can contain MP3 audio clips or MPEG2 video content. Further, it can be attached to other components such as a DVD/CD tower or other sources for audio or video content. Various inputs can be received into the home automation system such as content from a satellite dish, aerial antenna, cable or other sources for video content such as DVD players, game systems, and other content sources. Other possible input sources into the gateway server are the telephone system and analog or digital web cams. The gateway server is also connected to, via a local area network in one embodiment, one or more set top boxes, which preferably act as multi-media clients and servers. These set top boxes are useful to distribute video from particular sources to which they are connected to. A set top box that is acting as a server can be connected to a content source such as a DVD player, a satellite dish, etc. Of course, the various components can be configured in other ways depending upon the needs of the user.

One embodiment of the utility of the set top boxes in the home automation system of this invention is now described. In this embodiment, if a user has a satellite dish connected to a set top box in the basement and desires to watch a program from the satellite dish in his bedroom, they can simply enter the appropriate command into their input device such as a touch screen display while sitting in their bedroom. The input device will send a command via the local area network to the set top box in the basement to tune to a particular channel and the video feed from that channel will be distributed over the network and picked up by the set top box in the user's bedroom for display to the TV located in the bedroom. The set top boxes can provide very particularized control of the equipment connected to them and provide integrated access to these devices throughout the home automation system.

Also connected to the gateway server are access points for other subsystems such as the security controller, the lighting controller, the HVAC controller. In turn these controllers are connected to their various components such as security sensors, light switches and thermostats.

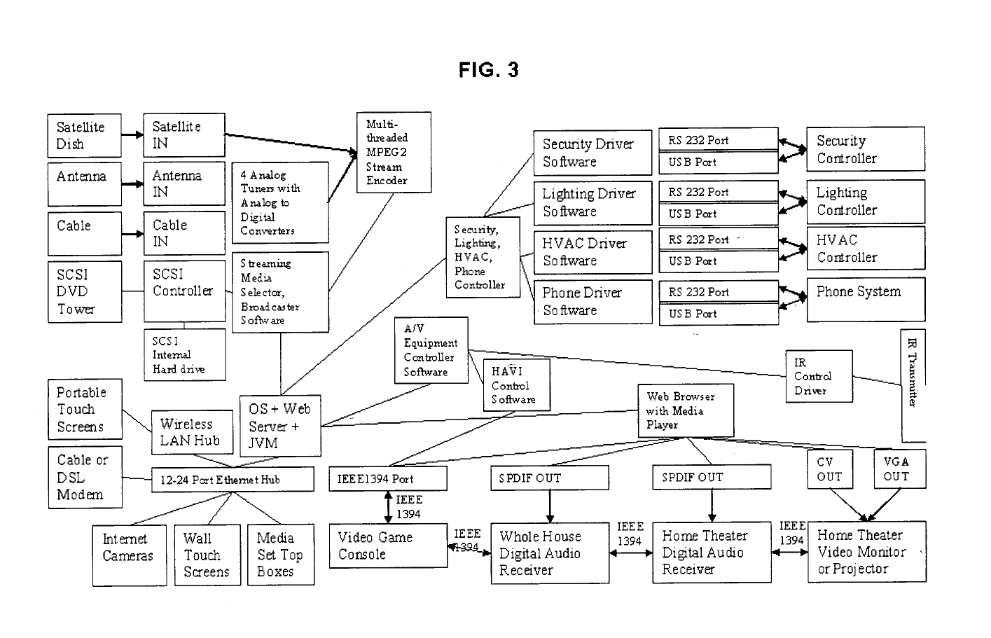

The gateway server of the embodiment shown in FIG. 2 is depicted in more detail in FIG. 3. In this embodiment, the gateway server has inputs for receiving information from various sources such as satellite dishes, aerial antennas, cables, etc. These inputs can be of any known standards such as RS-232, component video, S-Video, IEEE 1394 or the like. The incoming digital video inputs are preferably fed directly to an MPEG (i.e., Motion Pictures Experts Group) encoder or similar video codec. The MPEG encoder converts the incoming stream of video frames into a compressed stream of MPEG-2 data based on the MPEG-2 standard. Other standards such as MPEG-4 or other video compression standards yet to be developed can be used in place of MPEG-2. Any received analog video signals should be processed through the analog-to-digital converter (or other similar hardware) and the output of the analog-to-digital converter is fed into the MPEG-2 encoder. The MPEG-2 video stream is then broadcast over the local area network, such as the Ethernet, using streaming media server software. Such streaming media software is commercially available from sources such as Real Networks and can be adapted to operate within the gateway server. The gateway server of the preferred embodiment also contains a Linux operating system, a web server, and a JAVA™ virtual machine (JVM). However, these components can be replaced by other currently available operating and networking software or such software which may be developed for operating systems or networking in the future.

The Linux OS, the web server, and the JVM are included to make the home automation system web-enabled and to make the server application software run using standard web-based design. These three components provide a foundation to make the server application software run within a web-based paradigm, which simplifies interoperability and programmability. The set top boxes of this invention discussed below also operate on a web-based paradigm so that the programming of a system is simplified and easily implemented. The gateway server should have a variety of outputs such as connections to the security controller, lighting controller, HVAC controller and the phone system. Potentially, there are also a series of video outputs that can be added to the gateway server to provide the output functionality of a set top box from the server itself. Implementation of certain application and use cases are illustrated in FIG. 3; such as the A/V equipment controller software and the HAVI™ controlled software. Furthermore, network enabled devices such as portable touch screens, cable or DSL modems, Internet cameras, wall mounted touch screens, or media set top boxes can be directly connected to the gateway server through the Ethernet Hub.

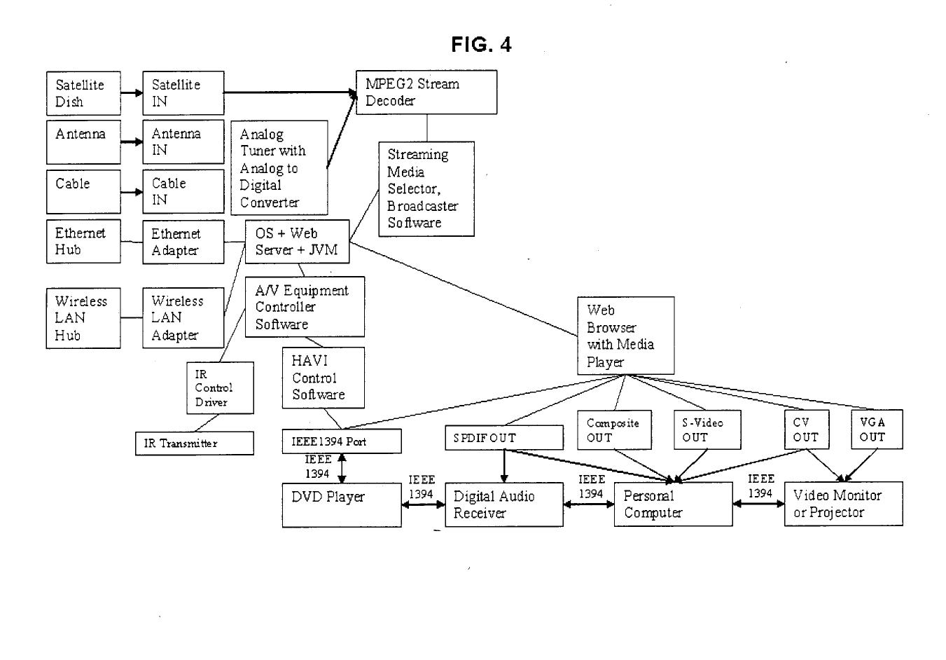

An embodiment of the set top boxes useful for the implementation in the home automation system of this invention is illustrated in FIG. 4. This illustrative set top box (as can the gateway server) can be incorporated in one or multiple units depending on the functionality that needs to be included. For example, separate set top boxes can be used for clients or servers in the home automation system. With respect to FIG. 4, it is illustrated that the set top box can receive various input sources. These input sources are processed by an MPEG-2 or comparable encoder or decoder. If the set top box is acting as a server, the incoming video will be encoded by the MPEG-2 encoder/decoder and if it is acting as a client the MPEG-2 encoder/decoder will act as a decoder. Further, analog video information will be converted by the analog-to-digital converter and fed into the MPEG-2 encoder/decoder. Similar to the gateway server, the set top box will preferably include a Linux OS, a web server and an interpreter or compiler such as JVM or comparable operating system and networking software. This allows the set top box to be programmed in the same manner as the gateway server. Further, the set top box can have a wireless or wired local area network connection to interface with other set top boxes and the gateway server. The web browser will have a media player so that it can display content received from components attached to it or from components elsewhere in the home automation system and display such content on an attached display such as a television, LCD panel, or other display device.

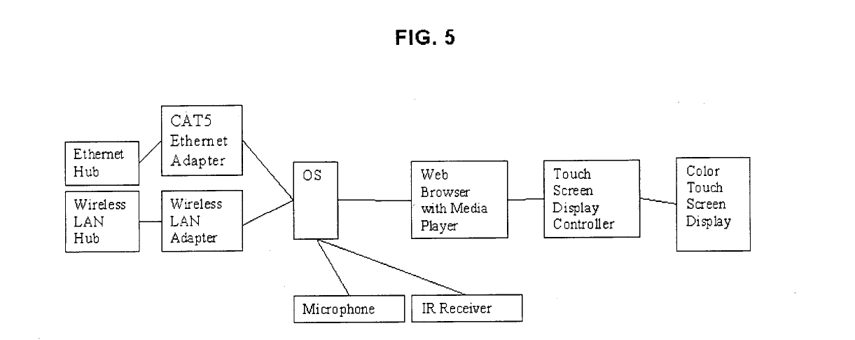

FIG. 5 depicts an illustrative embodiment of an access point to the home automation system in the form of a touch screen controller. The touch screen controller of this embodiment contains a display controller, a web browser with a media player, which enables a user to view the content on the touch screen controller, and an operating system which is loaded onto the touch screen controller. Such operating system can be any conventional operating system developed for consumer applications, such as Window CE™, various versions of Linux or other appropriate operating systems that are not too voluminous. Incidentally, Windows™ based can be used on the gateway server and set top boxes as well. Optionally, a microphone can be included on such touch screen controller so that it can be used as an intercom to other touch screen controllers or other components of the home automation system, such as the telephone system. Optionally, a proximity sensor can be connected to the touch screen controller so that it can wake up when it senses the presence of someone entering the room. Further, the touch screen controller can incorporate their component such as a digital camera to add the ability to have a video conference over the home automation system. The touch screen controller may be connected to the home automation system through a wired, wireless local area network adapter or other known or hereinafter developed means.

As described with regard to the figures of the specification, the hardware the components such as the gateway server and set top box access are all web enabled. This allows a user to hook into the home automation system by accessing the URL for the system. After accessing this URL, the system can receive any HTTP requests from the device by which the user has accessed the system. This access can be provided through the touch screen displays described above or from any other web-enabled device such as a personal computer, a PDA, a wireless phone, or a table PC. These web-enabled devices can come fully integrated into the home automation system and can access the aforementioned application and use cases. By contrast, a home automation system that is not web-based would require specialized software to be loaded on each component that is to serve is to act as a client or server on the system. Such software commonly is not available for such devices since they are heterogenous and there is little movement to integrate such devices into an open system such as one using the web-based protocol. Such pervasive integration of a home automation system using an open standard has been achieve prior to this invention.

Thus from the above-described embodiment, for the first time, it has been realized a truly open system which requires no specialized software to be loaded on the components which are accessed points to the system. Further, only through use of this invention can the web-based protocols be accessed without specialized knowledge of a proprietary software programming interface.

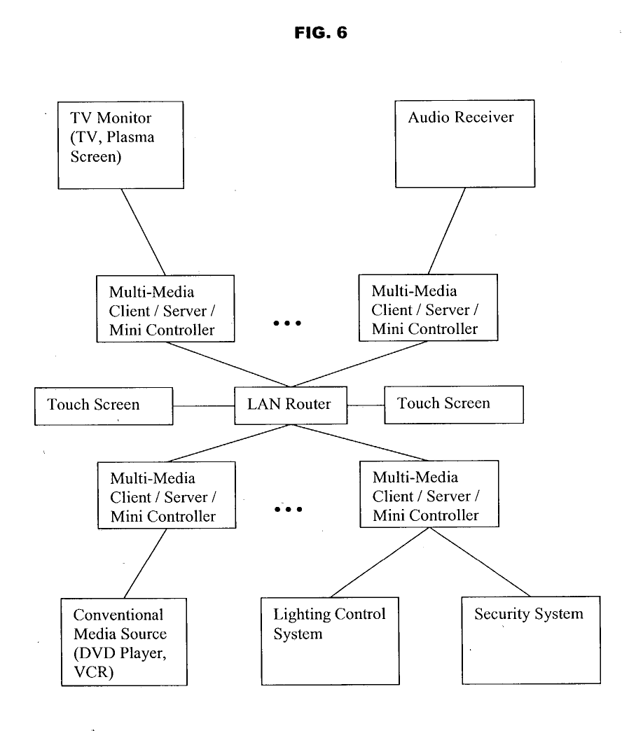

An alternative embodiment of this invention is illustrated in FIG. 6. In this alternative embodiment there is no gateway server. Each of these set top boxes are connected to the local area network and to each other through a local area network hub. In this embodiment one set top box will act as a the primary web server for the system. For example, a user accessing the home automation system through a data input device such as a touch screen display will enter their command which will be transmitted to the set top box acting as the server. This command will be routed to the appropriate set top box which is needed for implementation of the command and if more than one set top box is involved the set top box acting as a server will coordinate the activities of the multiple boxes. This embodiment makes the system infinitely scalable and distributed.

Now that the preferred embodiments of the present invention have been shown and described in detail, various modifications and improvements thereon will become readily apparent to those skilled in the art. The present embodiments are therefor to be considered in all respects as illustrative and not restrictive, the scope of the invention being indicated by the appended claims, and all changes that come within the meaning and range of equivalency of the claims are therefore intended to be embraced therein.

What is claimed is:

1. A system for automating and integrating home and/or office subsystems comprising:
at least one server;
at least one input device for accessing application and/or use case commands written in a mainstream programming language stored on the system;
at least one device interfaced to said subsystems and in communication with said server via a network;
a device location application database for storing information relating to components of the subsystems that are installed in the office or home automation system; and
a generic device command framework stored on said system for converting said application and/or use case commands into a format compatible with said home and/or office subsystems, wherein said application and/or use case commands and said generic device command framework provide for integrated and automated control of said home and/or office sub-systems when connected to said system.

2. The system of claim 1, wherein said at least one server and said at least one interfaced device are web-based.

3. The system of claim 1, wherein said application and/or use case commands allow a remote operator to access the system by use of a password sent to the remote operator by the system upon detection of a security alert.

4. The system of claim 1, wherein said application and/or use case commands allow a user to save a lighting scene that has been set on components of a lighting subsystem.

5. The system of claim 1, wherein said application and/or case use commands include instructions for controlling a lighting subsystem, HVAC subsystem, security subsystem, video subsystem and/or audio subsystem.

6. The system of claim 1, wherein said at least one device operates as a client and/or server for audio and video content and for control of said subsystem.

7. The system of claim 1, wherein audio and/or video content originating from a first conventional, non-computing component of said subsystem can be played back on a second non-computing component of said subsystem using said network and standard networking and web-based protocols.

8. The system of claim 7, wherein said first non-conventional component is a DVD player, cable TV or satellite receiver and/or VCR and said second non-conventional component is an audio receiver and/or television.

9. The system of claim 1, further comprising a two-way touch screen control system user interface using the content enabling technology.

10. A method for automating and integrating home and/or office subsystems comprising the steps of:
storing information relating to components of said subsystems;
interfacing, via a network, at least one device for controlling said at least one home and/or office subsystem to at least one server;
generating, in a mainstream programming language, application and/or use case commands for controlling said home and/or office subsystems based on said information relating to components of said subsystem; and
converting said application and/or use case commands into a format compatible with said home and/or office subsystems, wherein said converted application and/or use case commands provide for integrated and automated control of said home and/or office sub-systems when connected to said home and/or office subsystems.

11. The method of claim 10, wherein said application and/or use case commands are written using web based standard protocol.

12. The method of claim 11, wherein said web based standard protocol is HTTP and/or XML.

13. The method of claim 10, further comprising the steps of receiving user commands for controlling said home and/or office subsystems and sending said commands to said server.

14. The method of claim 10, further comprising the step of assigning a URL for said components of said home and/or office subsystems.

15. The method of claim 10, wherein said application and/or case use commands include instructions for controlling a lighting subsystem, HVAC subsystem, security subsystem, video subsystem and/or audio subsystem.

16. The method of claim 10, further comprising the step of providing access to said subsystems to a remote operator for monitoring said subsystems.

17. The method of claim 10, further comprising the step of interfacing said components of said subsystems to act as a client and/or server so that said components can send and receive information to each other.

18. An apparatus for automating and integrating home and/or office subsystems comprising:
means for storing information relating to components of said subsystems;
means for interfacing, via a network, at least one device for controlling said at least one home and/or office subsystem to at least one server;
means for generating, in a mainstream programming language, application and/or use case commands for controlling said home and/or office subsystems based on said information relating to components of said subsystem; and
means for converting said application and/or use case commands into a format compatible with said home and/or office subsystems, wherein said converted application and/or use case commands provide for integrated and automated control of said home and/or office sub-systems when connected to said home and/or office subsystems.

19. The apparatus of claim 18, wherein said application and/or use case commands are written in web based standard protocol.

20. The apparatus of claim 19, wherein said web based standard protocol is HTTP and/or XML.

21. The apparatus of claim 18, further comprising means for receiving user commands for controlling said home and/or office subsystems and means for sending said commands to said server.

22. The apparatus of claim 18, further comprising means for assigning a URL to said components of said home and/or office subsystems.

23. The apparatus of claim 18, wherein said application and/or case use commands include instructions for controlling a lighting subsystem, HVAC subsystem, security subsystem, video subsystem and/or audio subsystem.

24. The apparatus of claim 18, further comprising means for providing access to said subsystems to a remote operator for monitoring said subsystems.

25. The apparatus of claim 18, further comprising means for interfacing said components of said subsystems to act as a client and/or server so that said components can send and receive information to each other.
